(19) United States
(12) Patent Application Publication
(10) Pub. No.: US 2025/0301957 A1
(43) Pub. Date: Oct. 2, 2025

(54) HARVESTING SYSTEM AND METHOD

(71) Applicant: IG Specials B.V., GAMEREN (NL)

(72) Inventors: Wim STRUIJK, DELWIJNEN (NL); Roelof Johannes OOMEN, GAMEREN (NL); Willem Lambertus VAN DER MEIJDEN,, GAMEREN (NL)

(21) Appl. No.: 18/866,587

(22) PCT Filed: May 25, 2023
(86) PCT No.: PCT/NL2023/050300

§ 371 Date: Nov. 18, 2024

(30) Foreign Application Priority Data
May 25, 2022 (NL) 2031985

(51) Int. Cl. A01D 46/30

(52) U.S. Cl. CPC A01D 46/30

(57) ABSTRACT

There is provided a harvesting system for harvesting crop items from plants grown in rows. The system is provided with a harvesting-cart for harvesting crops, the harvesting-cart having a detection unit that is arranged to identify crop items for harvesting; a crop picking tool arranged to pick crop items identified by the detection unit; a collection zone arranged to accept a crop-container. The harvesting-cart is arranged to be movable along inter-crop lanes defined between said rows of plants. Transport-carts are further provided, with each transport-cart arranged to be detachably coupled to the at least one harvesting-cart, each transport-cart comprising a holding region for storing a plurality of crop-containers. A service-cart is provided for loading and transferring said transport-carts, and preferably said harvesting-cart, to and from said inter-crop lanes.

### BACKGROUND OF THE INVENTION

### 1. Technical Field

The invention generally relates to a harvesting system for harvesting crops that are grown in rows, preferably parallel rows; and a method for harvesting crops that are grown in rows. The invention also relates to a harvesting-cart, to a transport-cart, and/or to a service-cart for use in a harvesting system for harvesting crops grown in rows, preferably parallel rows. Furthermore, the invention can relate to an apparatus and method for harvesting crops, and to a method of providing a harvested crop, and an apparatus for providing a harvested crop.

### 1.1 Background

In agriculture, crop-plants may generally be grown in a series of parallel rows of growth medium. The rows of crops are generally arranged with access lanes therebetween. The access lanes allow access for inspection, care, harvesting, servicing, and other tending of the plants.

In an environment such as a greenhouse, the lanes may be equipped with heat-exchange tubes for controlling the temperature of the greenhouses, for example for provision of heat, but also possibly cooling, and may be paved or unpaved. Crops may also be grown in greenhouses without heat exchanger tubes.

In outdoor agricultural fields, plants may be grown in similar patterns of parallel rows with intermediate access lanes between the rows.

Crop plants that are grown in rows in greenhouses can include fruits (apples, oranges, kiwis, berries of all types, such as raspberries, strawberries, blueberries etc.) and vegetables (tomatoes, cucumbers, peppers, aubergines, root vegetables, broccoli, sweetcorn, squash, salad, peas, cabbages etc.).

Upon maturation or ripening of a crop, the crop must be harvested. Regardless of the indoor or outdoor setting, the selection and picking of ripe crops, especially those growing on vines, has conventionally relied heavily upon manual human labour, resulting in high harvesting costs and other concerns associated with manual harvesting.

For example, the work is arduous, not least because it is often done in greenhouses operating at high temperatures (e.g. 28 degrees Celsius and above) with air compositions (oxygen, carbon dioxide, humidity and nitrogen) that may differ from ambient compositions, in order to advance plant growth. In addition, interaction between manual harvesters and the crops may lead to an increased risk of disease transmission (viral, fungal, bacterial) between plants and even between separate growing areas or greenhouses.

There is thus a desire to improve the harvesting of crops. Attempts to provide improvements have been made previously through the provision of picking devices.

For example, EP3082397B1 discloses a picking apparatus for selectively harvesting crops on a plant, the picking apparatus being rotatable around a central axis. The picking apparatus includes a plurality of grippers each spaced apart and extending radially from the central axis, and each is configured to pick a different individual one of the crops. Each of the plurality of grippers can be configured in a closed position to securely hold the individual crop when the picking apparatus is rotated around the central axis.

EP3498076B1 discloses a machine for automatic harvesting of fruits cultivated in rows, formed by a self-propelled and autonomous vehicle. The machine comprises a pair of parallel rails, a fruit collector assembly with a carriage movably mounted on the pair of parallel rails and a collector robotic arm movably mounted on the carriage for moving transversely with respect to the carriage, a carriage motor for moving the carriage, and a robotic arm motor for moving the robotic arm. The carriage motor and the robotic arm motors are attached to the carriage. The carriage is movable horizontally and the robotic arm is transversally movable with respect to the rails.

WO2020/089768A1 discloses a harvesting system which includes a vertical frame, a plurality of linear robots, a plurality of cameras and a processor. The vertical frame is configured to be positioned opposite a sector to be harvested. The robots are arranged in pairs stacked vertically in the frame, each pair including first and second robots that are configured to move together along a vertical axis, to move independently of one another along a horizontal axis, and have respective first and second robot arms that are configured to approach the sector and harvest fruit. The plurality of cameras is configured to acquire images of the sector. The processor is configured to identify the fruit in the images and control the robots to harvest the fruit.

EP3854202A1 discloses a tube rail cart having a loading floor or loading space and which is provided on at least one of the front sides with a work platform, wherein the tube rail cart is further provided with an automated handling system for automatically supplying empty packaging and removing full packaging between the loading floor or loading space and a work platform, and vice versa, and stacking empty and full packaging on the loading floor or in the loading space without any direct intervention of the user or harvester.

The above cited documents require unloading of the harvested crops from the picking devices to the final storage location. Therefore, there is a general and ongoing need for a harvesting system having improved efficiency of picking and transporting of the crops, and/or inspection, care, servicing, and other tending of crops.

DE102015111650A1 discloses a harvesting system for fruit harvesting, having a picking trolley and a transport trolley.

US2022111913A1 discloses a mobile drive unit and method of operation related to autonomous or automated robotic or automation platforms, which are able to perform automated tasks, more particularly in the field of agriculture, horticulture, etc.

WO2019125134A1 discloses a harvesting vehicle. More particularly, the invention relates to a fruit harvesting vehicle for picking fresh fruit bunches with minimal damage to the fruits and improved manoeuvrability in palm oil plantation which its ground consists of peat soil and uneven terrain.

CN109005923A discloses a fully automatic fruit picking device for picking fruits from trees.

Gains in processing and harvesting of crops remains desirable, preferably providing rapid harvesting, energy efficiency, reduced or minimal manual labour.

### Discussion of the Invention

According to a first aspect of the invention there is a provided a harvesting system for harvesting crops from plants grown in rows, comprising at least one harvesting-cart, a plurality of transport-carts and a service-cart. In embodiments, the at least one harvesting-cart is arranged to harvest said crops. In embodiments, the harvesting-cart comprises: a detection unit, preferably a camera unit, preferably a visual camera unit, arranged to identify crop items for harvesting. In embodiments, the harvesting-cart comprises a crop picking tool arranged to pick crop items identified by the detection unit. In embodiments, the harvesting-cart preferably has a collection zone arranged to accept a crop-container, said crop-container arranged to receive picked crop items. In embodiments, the harvesting-cart is arranged to be movable along inter-crop lanes defined between said rows of plants. In embodiments, each transport-cart is arranged to be detachably coupled to the at least one harvesting-cart. In embodiments, each transport-cart comprises a holding region for storing a plurality of crop-containers.

In embodiments, the service-cart is arranged to transfer said transport-carts, and preferably said harvesting-cart, to and from said inter-crop lanes. This allows the service-cart to transfer the transport-cart and/or harvesting-cart from one inter-crop lane to another.

The harvesting system according to the present invention may assist in reducing the level of human labour required for picking and harvesting of crops. As a result, the required time and costs of a picking process may be reduced per crop quantity.

In addition, by minimizing the human labour factor, the risk of virus/disease spreading is also reduced due to reduced exposure of the crops to workers moving between plants, crop locations, and/or greenhouses. In preferred embodiments, the harvesting system, or any part thereof may be provided with one or more cleaning or disinfection units. The cleaning or disinfection units may be configured to automatically carry out a cleaning or disinfection step at a predetermined time, for example after a period of harvesting time, after harvesting of each of a given number of rows. Cleaning or disinfection may also be carried out following detection of (suspect) diseased or ill plant material by the detection unit.

The buffer region in the at least one transport-cart improves the efficiency of the collection of crops. In particular, the crops which are harvested by the harvesting-cart may be retrieved by the transport-cart. This reduces the amount of movement required by the harvesting-cart during the harvesting process.

In a preferred embodiment, the transport-cart moves from the service-cart to the harvesting-cart, such that the harvesting-cart does not need to move away from the region where it is harvesting. As a result, the harvesting-cart is allowed to continue harvesting crops without interruption. Further, the transport-cart is arranged to move along the lanes to both load empty containers onto the harvesting-cart and to unload filled containers from the harvesting-cart. As such, the capacity needed to continue the harvesting process is provided by the transport-cart to the harvesting-cart.

The system and method according to embodiments disclosed herein can be used in a crop-growing field, wherein crops are grown in multiple rows. Between two rows of crops, inter-crop lanes are available. Multiple inter-crop lanes are available. The inter-crop lanes can be lanes extending generally parallel to each other. At an end of the inter-crop lanes a connecting main lane can extend generally perpendicular to the inter-crop lanes. By moving along the connecting main lane, a device can move from one inter-crop lane to another. Inter-crop lanes can extend on both sides of the connecting main lane. In embodiments, the service-cart can move in the connecting main lane, thereby moving from one inter-crop lane to another parallel inter-crop lane.

In an alternative embodiment, the transport-carts are unpowered. The transport-carts can then be collected from the service-cart and returned to the service-cart under the power of the harvesting-cart, to which one or more service-carts are coupled.

In embodiments, the service-cart is arranged to load one or more transport-carts and/or the harvesting-cart. By having a service-cart that can load one or more transport-carts, it is possible to cumulatively collect the harvested crops from neighbouring inter-crops lanes, thereby reducing logistical traffic load. Also, the number of journeys required between the inter-crop lanes and the storage location can be minimized. Accordingly, the service-cart can load carts and carry the loaded carts as the service-cart moves across inter-crops lanes. In embodiments, a service-cart is configured to load a harvesting-cart and/or transport-carts by means of carrying a majority of their weight so that it is able to transport it. By loading the transport-cart and/or the harvesting-cart, the service-cart that is provided with a drive for moving across the inter-crops lanes, the transport-cart and/or harvesting-carts can move across inter-crop lanes without a drive. In particular, transport-cart and/or harvesting-cart can do without passive or active driving and turning to move the cart from a first inter-crop lane to the main connecting lane into a second inter-crop lane. This results in a cost saving for the driving unit of those carts and can result in space saving as steering is not necessary. Also, rail that supports the carts in the inter-crop lane can be disconnected from rails in the main connecting lane. This allows saving expensive railroad switches. The harvesting-cart and/or transport-carts are movable along the inter-crop lanes, e.g. using wheels. By loading the respective cart onto the service cart, the service cart supports the weight of the harvesting-cart and/or transport-carts and thereby the service-cart controls the movement of those carts along the main connecting lane across different inter-crop lanes. In embodiments, a loaded carts can still be partially supported by its wheels.

Loading of cart(s) onto the service-cart addresses the issue of high complexity when implementing harvesting systems in greenhouses or other locations where crops are harvested from plants that lack existing infrastructure for accommodating harvesting systems. Known systems, which have (cascades) of cart(s) navigating from one inter-crop lane to another inter-crop lane, often require complex mapping- and motion planning algorithms that may impose large hurdles for implementation. In embodiments of the invention these hurdles are removed by limiting the degrees of freedom of the harvesting-carts and transport-carts to only include a path from the start of a single inter-crop lane to its end.

To allow harvesting-carts and/or transport-carts to reach other inter-crop lanes, harvesting-carts and/or transport-carts may be loaded onto a service-cart. After loading, the service-cart is then capable of dropping off harvesting-carts and/or transport-carts—collectively or individually—at a desired location. This desired location may be the start or end of an inter-crop lane, or any location in the vicinity of the start or end of the inter-crop lane. Once the service-cart has arrived at the desired location, the harvesting-cart and/or transport-cart that were loaded onto the service-cart may then be unloaded from the service-cart. Once unloaded, the harvesting-carts and/or transport-carts may then proceed with traversing within the inter-crop lane at which they were dropped off.

Another advantage of loading the harvesting-cart and/or a plurality of transport-carts onto the service-cart is the decreased level of complexity of the power infrastructure of the system and an increased or even unlimited system runtime. Known systems have (cascades) of (harvesting and/or transport) carts navigating from one inter-crop lane to another inter-crop lane, often autonomously and with specialized software for optimal routing. Such systems commonly demand on-board batteries for powering said carts. Although often preferred, these systems are incompatible with wired powering solutions that make use of cables for providing power to carts, as wires are often not long enough to accommodate complex driving paths and may become tangled around corners. However, implementation of wired powering solutions is in fact compatible with the present invention. Namely, the present invention addresses the issue of high complexity of power infrastructures by not requiring service-carts, harvesting-carts and transport-carts to be rotated during use, thereby creating straight and unobstructed paths between service-carts, harvesting-carts, transport-carts, and power sources for wired powering solutions to be successfully implemented.

Service-carts described herein may be equipped with a (spring-driven) reel for housing a power cable that runs to a power source. In turn, the harvesting-cart and/or transport-carts may be powered through a power cable running from the service-cart to the harvesting-cart and/or transport-carts. Harvesting-carts and/or transport-carts may also be powered through a power cable running from the harvesting-carts and/or transport-carts to an external power source. Alternatively, the harvesting-cart and/or transport-carts may be powered by an on-board battery. In some embodiments, this battery may be charged through a powered docking mechanism located on the service cart that is activated when the harvesting-cart and/or transport-carts are loaded onto the loading platform of service-cart.

In embodiments, the loading of the harvesting-cart and/or a plurality of transport-carts onto the service-cart may be achieved by the service-cart lifting, carrying, and/or shovelling the harvesting-cart and/or a plurality of transport-carts. Loading the harvesting-cart and/or a plurality of transport-carts onto the service-cart, allows the harvesting-carts and/or transport-carts to be transported in a direction that lies outside their degrees of freedom without rotating the harvesting-carts and/or transport-carts themselves. After loading, the direction in which the service-cart transports the harvesting-carts and/or transport-carts may be substantially perpendicular to the driving direction of the harvesting-carts and/or transport-carts within the inter-crop lanes.

In embodiments, the service-cart can be provided with a lift for transport-carts and/or for the harvesting cart. By lifting, the service cart picks-up or delivers the carts from or to the (vicinity of) the start or end of inter-crops lanes. For delivering (unloading) or picking-up (loading) a lift is provided. Using the lift, transport-carts and harvesting-carts can be picked up from or delivered at inter-crops lanes.

In embodiments, the service-cart has a loading platform onto which one or more transport-carts and/or the harvesting cart can be loaded. Preferably a loading platform is provided for one harvesting cart and several transport-carts. In embodiments the loading platform comprises several adjacent spots for loading carts. In embodiments, the service cart is provided by a cart-drive for moving one or more loaded carts from one loading spot to another.

To allow loading a cart from the inter-crop lane onto or from the service cart, the service cart has a loading device arranged to load and/or unload in a direction generally perpendicular to the direction of the inter-crop lane. The direction generally perpendicular to the inter-crop lane is the direction of the main connecting lane. This allows loading or unloading the transport-cart or harvesting-cart onto or from the service-cart while maintaining the orientation of transport-cart or harvesting-cart generally aligned with the inter-crop lane. The orientation of the transport-cart or harvesting-cart is also maintained when the service-cart moves across different inter-crops lanes. The loading or unloading direction extends along the direction of the desired inter-crops lane, whereas the movement between inter-crop lanes is generally perpendicular to the loading/unloading direction.

The service-cart may be loaded with a plurality of transport-carts filled with empty crop-containers. When the crop-containers of a transport-cart have been filled with harvested crops, the service-cart can receive the filled transport-cart and immediately provide another transport-cart with empty crop-containers, to the harvesting-cart to allow continued harvesting.

The containers carried by the transport-carts are preferably boxes or crates or any kind of container known in the field of plant harvesting. The containers are generally arranged to be vertically stackable with similar or like containers in a stable manner. In a preferable embodiment, the containers may have handles for manual lifting.

In a preferred embodiment, the detection unit is arranged to identify and select ripe crops. The detection unit may be any unit that is suitable to detect crops and preferably a characteristic associated with a desired level of ripeness. Characteristics such as size, volume, firmness, softness and/or colour, may be considered in this respect.

The detection unit may be based on touchless detection techniques such as laser scan, LIDAR, sonar, radar, infra-red, ultraviolet, or visual spectrum light detection, or any combination of these.

It is preferred that the detection unit is a light sensitive camera unit, sensitive to at least one of the visual, infrared, or ultraviolet spectrums, preferably the visual spectrum. The camera is preferably polychromatic, with sensitivity to at least two of red, green, and blue, but may alternatively be monochromatic, bi-chromatic or tri-chromatic.

Preferably the camera unit defines pre-determined selection criteria for selecting the crops, more preferably wherein the pre-determined selection criteria comprise one or more of the state of ripeness, the level of degradation, and optical characteristics associated with disease or infection; preferably the selection criteria include one or more of: colour, size, aspect ratio and shape.

The detection unit, preferably camera unit, allows for detection and selection of the crops with pre-selected criteria, for example levels of ripeness, degradation, and disease infection. The detection unit, preferably camera unit, preferably comprises at least two separate detectors, preferably cameras, each facing one row of crops, such that the crops on the two rows neighbouring the lane can be simultaneously detected and selected.

The detector system may also comprise stereoscopic detectors, for example stereoscopic cameras. Stereoscopic data may be employed for analysis of shape, surface texture (such as smoothness, roughness, or shape deviations from idealized forms), or other 3D characteristics of a crop. Stereoscopic data may also be 3D employed to analyse and or determine an approach path for a harvesting tool, e.g. a robot and gripper, to pick the crop and manoeuvre it out of the vegetation.

The detection unit may preferably comprise a plurality of detection units, or detection sensors for each detection unit, arranged at different vertical locations for detection of crops at different heights in a row. The provision of detection at different vertical locations allows the harvesting system to harvest from the full height of the crops. For example, three or more detection units may be vertically provided on each side of the harvesting-cart, providing coverage for tall plants. In a preferable embodiment, a user may select the height of the crops, and subsequently the detectors at relevant height may be activated for detection and selection according to the selected height of the crops.

In a preferred embodiment, the harvesting-cart further comprises a temporary storage area for storing one or more of the containers. The temporary storage area of the harvesting-cart is arranged to store one or more empty or filled containers. The containers may be vertically stacked atop each other. The temporary storage area may be arranged to support multiple columns of vertically stacked containers. An empty container can be moved to the collection region for collecting harvested crops picked by the picking unit.

In an embodiment, harvested crop may be transferred directly to the transport-cart without first temporary storage within a temporary storage area of a harvesting-cart.

In a preferred embodiment, the picking unit preferably comprising a robotic arm carrying a picking head or grasping device. The picking head or grasping device may be appropriate to a given crop size, shape and/or fragility. Preferably, multiple picking tools may be provided for each harvesting-cart.

After filling the empty container, the filled container may be moved back to the temporary storage area. Provision of a temporary storage area in the at least one harvesting-cart allows harvesting to proceed without a transport-cart adjoined to the at least one harvesting-cart so that harvesting can proceed while a transport-cart is transported away from or to a harvesting-cart. This may enhance the efficiency of the logistical flow for harvesting because harvesting can continue while a transport-cart of full containers is exchanged for a transport-cart of empty containers.

The harvesting system may preferably further comprise a movement mechanism for the movement of the at least one harvesting-cart, the least one transport-cart, and/or the service-cart. The movement mechanism preferably comprises a plurality of wheels for moving on the ground, on tubes, or on rails installed on the ground. Preferably one or more of the wheels are driven.

By having a plurality of wheels, the harvesting-cart, transport-cart, and service-cart may move on the ground, on the tubes, or on rails installed on the ground. In a preferable embodiment, the movement may be along a guide wire defined on the ground.

In greenhouses it is common that the lanes between rows of crop plant are provided with heat-exchange tubes for controlling the temperature of the greenhouses, for example for provision of heat, but also possibly cooling. In preferred embodiments the harvesting-cart and transport-carts are arranged to travel atop the heat-exchange tubes. Most preferably, the harvesting-cart and/or transport-carts are provided with rail wheels. The wheels may be grooved, such that the wheels are adapted to stably ride over the heat exchange tubes. The carious carts may further comprise an alarm system to warning of movement of the carts.

The harvesting-cart of the harvesting system is preferably electrically powered. The electrical power is preferably provided by an electrical feed cable running from the service-cart to the harvesting-cart. More preferably, the harvesting-cart, transport-carts and service-cart are electrically powered. As an alternative an electrical feed cable, one more or all of the harvesting-system may be battery powered or be provided with battery power having a capacity to allow harvesting of one or a limited number of crop lanes prior to recharging. For example, a harvesting-cart may recharge upon docking with a service-cart.

The electric power supply from the service-cart to the at least one harvesting-cart provides a stable power connection to the camera unit and the picking tool of the harvesting-cart. The provision of a harvesting system comprising all of a harvesting-cart, a plurality of transport-carts and a service-cart supplying said transport-carts to the harvesting-cart, allows for advantages of automated harvesting across multiple rows of crop plants, yet while providing the harvesting-cart with an external electrical supply of power. This may be advantageous as compared to attempts to provide automated harvesting based on autonomous battery powered harvesting-carts, which entail considerable expense and significant down-time for recharging.

In a preferred embodiment, the harvesting system is provided with a movement control system for controlling the movement of the harvesting-cart, the plurality of transport-carts, and the service-cart.

Provision of a movement control system allows the movement and location of the harvesting-cart, transport-cart, and the service-cart to be precisely controlled by a user or by a pre-defined algorithm. In a preferable embodiment, the movement control system is a computer program of an external computer, wirelessly connected to the harvesting system. The computer program may pre-define the movement of the harvesting system for a harvesting event.

In a preferred embodiment, the harvesting system further comprises a connection control system arranged to control physical coupling between the harvesting-cart, the transport-carts, and the service-cart.

The harvesting-cart is preferably detachably couplable to one or more of the transport-carts. A plurality of harvesting-cart and/or transport-cart can be loaded on, hence connected with the service-cart. The connection is controlled by a connection control system.

In a preferred embodiment, one or more of the transport-carts comprises a container control unit for controlling the relative positions of containers in the number of containers based on the quantity of harvested crop.

By having a container control unit, the position of empty and/or filled containers can be controlled. By arranging the position of the containers, the transport-cart may efficiently provide empty containers to the harvesting-cart and subsequently receive filled containers and store in the buffer region.

In a further aspect of the invention there is provided a method for harvesting crops grown in rows, comprising the steps of:
delivering one or more of a harvesting-cart and a transport-cart to a designated lane between crop rows;
identifying crops for picking by way of a detection unit;
picking said identified crops using a picking tool on said harvesting-cart,
passing picked crops to one or more containers, preferably carried by said harvesting-cart;
preferably passing said one or more containers from the harvesting-cart to said transport-cart, wherein the transport-cart is arranged to be detachably connected to the harvesting-cart, and further comprises a buffer region for receiving a plurality of containers;
coupling the one or more of harvesting-cart and/or transport-cart to a service-cart, wherein the service-cart is arranged to move said transport-cart between designated lanes and a storage location along a direction substantially orthogonal to the lanes between the crops.

A method implementing use of a harvesting-cart, transport-carts, and a service-cart, the logistical efficiency of harvesting can be enhanced. A service-cart may transport one or more of harvesting-cart and transport-cart to a designated lane. A harvesting-cart move along a lane defined between two rows of crops. In a preferable embodiment, the harvesting-cart is detachably connected to a transport-cart. The harvesting-cart may detect and select the crops to be picked using a camera unit. After selecting the crops to pick, a robotic arm unit may pick the selected crops and collect the selected crops in a collecting region of the harvesting-cart, arranged to hold a container for receiving the crops. When the container in the collecting region is filled, the harvesting-cart may store the container in the transport-cart detachably connected to the harvesting-cart. The transport-cart comprises a buffer region for receiving a plurality of containers. After harvesting the designated lane, the transport-cart and the harvesting-cart may be reconnected to the service-cart for transportation. The service-cart may move along a direction substantially orthogonal to the lanes between the crops. The service-cart may deliver the connected harvesting-carts and transport-carts to a storage location or to a next designated lane for additional harvesting. The logistical method described herein can enhance the logistical efficiency of harvesting by reducing the number of journeys a harvesting device has to travel between the crops and the storage location.

The harvesting-cart, transport-carts, and service-cart may comprise any of the characteristics as previously described.

### BRIEF DESCRIPTION OF THE DRAWINGS

The features and advantages of the invention will be appreciated upon reference to the following drawings, in which:

FIG. 1 is an overhead view of a system for harvesting crops grown in adjacent rows of crops;

FIG. 2 is a partial perspective view showing the system of FIG. 1;

FIG. 3 is a perspective view of a harvesting-cart and a transport-cart coupled;

FIG. 4 is a perspective view of a harvesting-cart;

FIG. 5 is a side elevation of a harvesting-cart and a transport-cart coupled;

FIG. 6 is an illustration of a crop-picking tool;

FIG. 7 A-F show an example implementation of the harvesting system for harvesting crop items from plants grown in rows performing the method for harvesting crops grown in rows.

### DESCRIPTION OF ILLUSTRATIVE EMBODIMENTS

It will be appreciated that for simplicity and clarity of illustration, where considered appropriate, reference numerals may be repeated among the figures to indicated corresponding or analogous elements or steps. In addition, numerous specific details are set forth in order to provide a thorough understanding of the embodiments described herein. However, it will be understood by those of ordinary skill in the art that the embodiments described herein may be practiced without these specific details. Furthermore, this description is not to be considered as limiting the scope of the embodiments described herein in any way, but rather as merely describing the implementation of the various embodiments described herein.

The following is a description of certain embodiments of the invention, given by way of example only and with reference to the drawings.

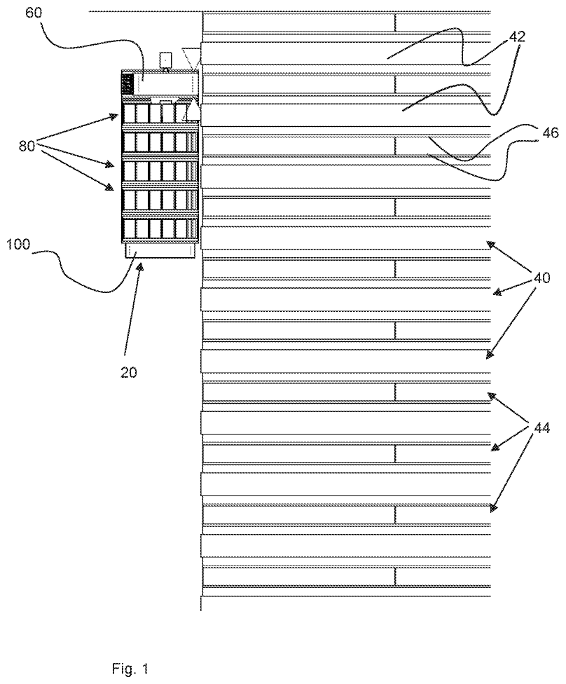

Referring to FIG. 1, there is shown an overhead view of a system 20 for harvesting crops 40 grown in adjacent parallel rows of plants 42. Between the parallel rows of plants 42 a inter-crop lane 44 are provided that allow access to the flanks of the plant rows 42. In each of the inter-crop lane 44 heat exchanger tubes 46 may be provided. The heat exchanger tubes 46 may be typically found in greenhouses where they assist in temperature regulation of the internal environment. The tubes 46 extend in an inter-crop lane direction along the rows of plants 42.

The parallel layout of plant rows 42 with intervening inter-crop lanes 44 may be used in various agricultural locations, such as in greenhouses and in open fields. At ends of the inter-crop lanes 44 a main connecting lane is present that connects to multiple ends of the inter-crop lanes 44. By moving in a direction perpendicular to the inter-crop lanes 44, one can move across different inter-crop lanes 44.

Access to the plants 42 via the inter-crop lanes 44 allows the plants to be tended and harvested. Traditionally, tending and harvesting has required much manual labour. The present invention may assist in reducing the level of manual labour, preferably while efficient and accurate harvesting via an economically efficient system.

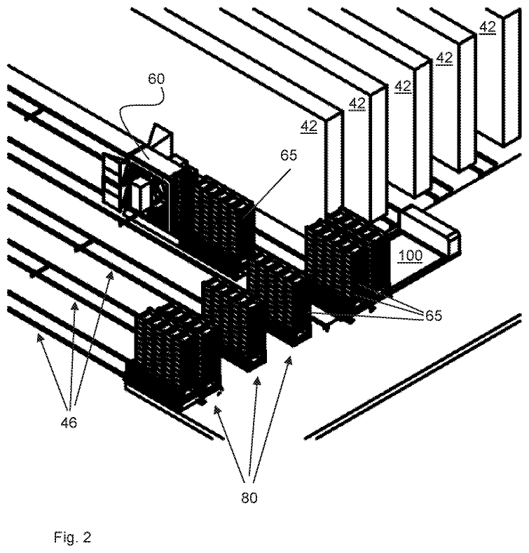

Harvesting of the crop is done by way of the harvesting-system 20, which is illustrated in FIG. 1 and FIG. 2.

The harvesting-system 20 is provided with a harvesting-cart 60, a plurality of transport-carts 80, and a service-cart 100. The service-cart 100 conveys or carries a plurality of the transport-carts 80, which are stacked with crop containers 65, and a harvesting-cart 60 to the open ends of the intercrop rows 44. The service-cart 100 is arranged for loading and unloading one or more harvesting-cart 60 or transport-carts 80. The service cart 100 is positioned in the main connecting channel near ends of the inter-crop lanes 44. The one or more transport-carts 80 or harvesting-cart 60 can be loaded onto a loading platform of the service cart 100. By loading the one or more transport-carts 80 or harvesting-cart 60 onto the service cart 100 the weight of those carts is for the most part supported by the service cart.

The harvesting-cart alights from the service-cart 100 and enters an unharvested intercrop row 44 (crop rows have been removed in the FIG. 2 to provide a visual of the equipment). To allow the unloading, the service-cart 100 is moved in the main connecting lane to a position at which that harvesting cart 60 is generally aligned with the desired inter-crop lane. The harvesting-cart 44 then mechanically couples to an unfilled, preferably crop-empty, transport-cart 80 from the service cart 100, and conveys the transport-cart 80 into the unharvested intercrop row 44. In FIG. 2, the harvesting-cart 60 is shown with a coupled transport-cart 80 carrying crop containers 65, part way up an intercrop row 44.

In the shown embodiment, the one or more transport-carts 80 or harvesting-cart 60 are loaded by the service cart 100 in an orientation that corresponds with the orientation of the one or more transport-carts 80 or harvesting-cart 60 when they move in the inter-crop lane along the row of crops. As the one or more transport-carts 80 or harvesting-cart 60 are held in that orientation, no steering is necessary during unloading of the one or more transport-carts 80 or harvesting-cart 60 into the inter-crop lane 44. Similarly, during loading, no turning of the one or more transport-carts 80 or harvesting-cart 60 is necessary.

As can be seen, the harvesting-cart 44 and transport-cart 80 in FIG. 2 are riding upon heat exchanger tubes 46, which may provide useful rails for travel. That can be advantageous, but it is not necessary. For example, in alternative systems, wheels or tracks may ride across a paved path or bare growth medium

Once in the unharvested intercrop row 44, the harvesting-cart 60, described in greater detail below, proceeds to detect ripe crop and harvest that crop from the plants 42, placing harvested, ripe crop into crop containers 65. Once filled, the filled crop containers 65 are returned to the transport-cart 80 and are exchanged with remaining empty crop containers 65, which are then filled with crop. This process continues until alternative action is required, for example the transport-cart 80 has no further empty crop containers 65 or no more suitably ripe crop is detected by the harvesting-cart 60 in the row.

In case no further empty crop container 65 is available, the full transport-cart is returned towards the end of the inter-crop lane. The harvesting cart 60 can transport the crop filled transport-cart 80 to the end of the inter-crop lane. The full transport-cart is then decoupled.

In FIG. 2 several full transport-carts 80 are shown positioned away from the service cart 100 in the main connecting lane. In embodiments, a full transport-cart is moved into the main connecting lane, is not loaded onto the service cart as the service cart is moved away (in FIG. 2: the service cart is moved away by moving to the right). By then moving the service cart 100 to a position wherein the loading platform is again aligned with the inter-crop lane, the full transport-cart 80 is pushed towards the left in FIG. 2. Full transport-carts are then ready for pick-up by e.g. a worker.

Next, an unfilled cart can be coupled to the harvester-cart 60 that is still present in the inter-crop lane to continue harvesting in that inter-crop lane.

In case no more suitable ripe crop is detected in a first inter-crop lane, the harvesting-cart 60 returns to the service cart 100, where the transport-cart 80 is decoupled and the harvesting-cart 60 is transferred by the service cart 100 to a new, unharvested row 44.

The process is substantially repeated until the required crop has been harvested.

Although the system and method are illustrated with coupling of carts, with automatic crop ripe detection and with a specific crate handling system by the harvesting-cart and transport-cart, the advantages of the invention as result of the service-cart loading other carts can be achieved also without these illustrated features.

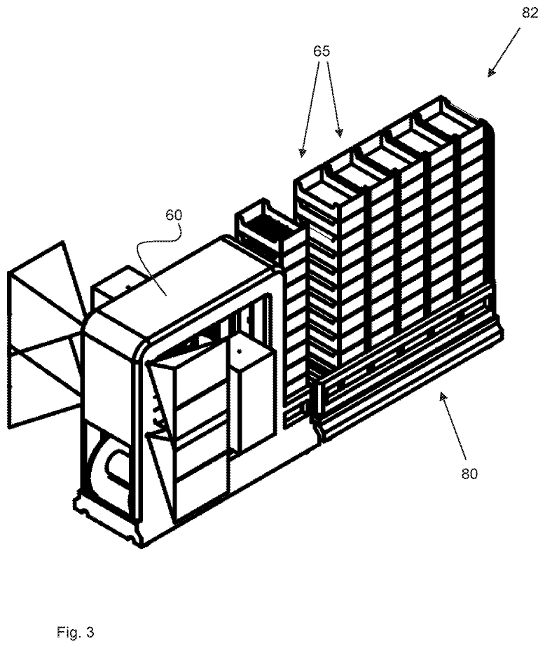

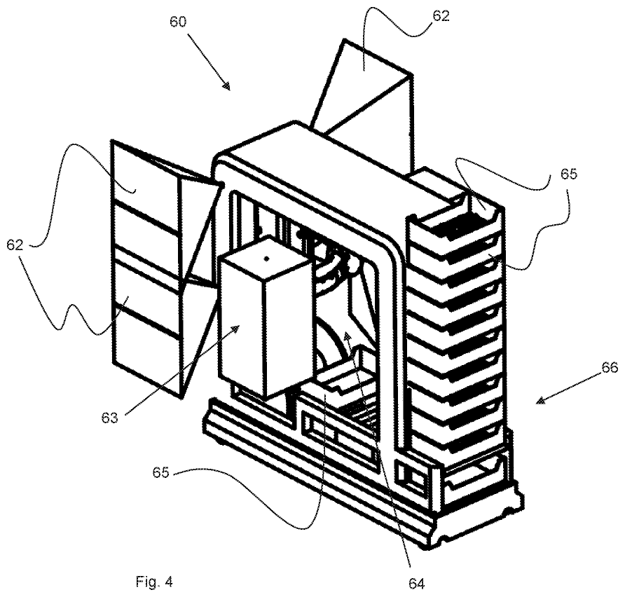

A more detailed illustration of the harvesting-cart 60 and a transport-cart 80 coupled thereto is provided in FIG. 3. As illustrated, the transport-cart 80 is stacked with a plurality of crop containers 65, in the form of crates, in a holding region 82. The empty crates 65 are provided to the harvesting-cart 60 for filling with harvested crop, before being returned to the transport-cart 80.

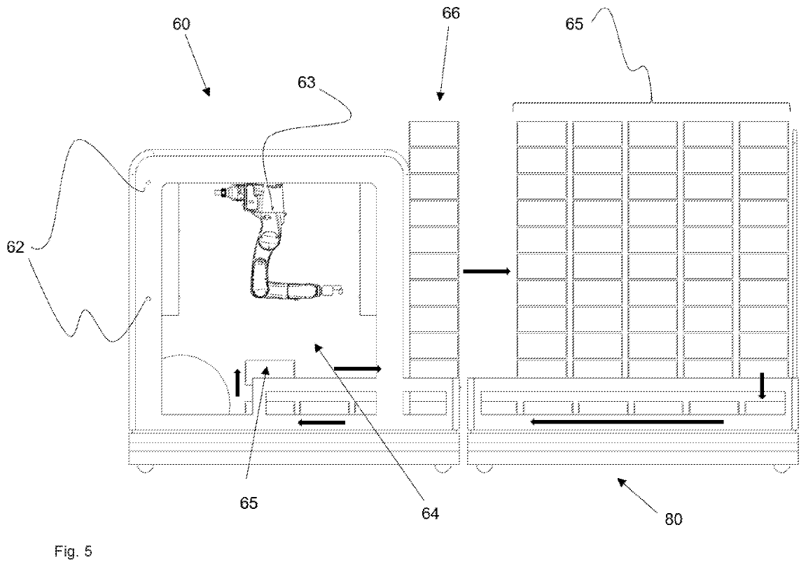

A more detailed illustration of the harvesting-cart 60 is provided in FIG. 4.

The harvesting-cart 60 is provided with detection units 62 on each of its side to detect adequately ripe crop in adjacent plants. The detection units 62 make use of touchless detection techniques such as laser scan, LIDAR, sonar, radar, infra-red, ultraviolet or visual spectrum light detection, or any combination thereof. Colour inspection in the visual spectrum is advantageous.

The detection units 62 are also provided at different heights to allow detection of crops over the height of tall plants.

The illustrated harvesting-cart 60 is provided with a temporary storage area 66 for storing one or more of the containers 65. The temporary storage area 66 of the harvesting-cart 60 is arranged to store one or more empty or filled (preferably filled) containers 65. The containers 65 are vertically stacked atop each other.

Empty containers 65 are arranged to be moved into a collection zone 64 where they may be filled with harvested crop. The collection zone 64 is illustrated as comprised in the harvesting-cart 60. Alternatively, the collection zone 64 may be comprised in the transport-cart 80 or be comprised in both the harvesting-cart 60 and transport-cart 80.

A crop-picking tool 63 is provided, which is arranged to pick harvestable crop from adjacent plants. The picked crop is moved to the container 65 in the collection zone 64. Once the container 65 has been filled, it is transferred from the collection zone 64 to the temporary storage area 66 of the harvesting-cart 60, and thereafter to the transport-cart 80.

The sequence for picking crop and filling the containers 65 is further illustrated in FIG. 5, which provides a side elevation of the harvesting-cart 60 and transport-cart 80. The harvesting-cart 60 in the illustrated embodiment is shown with five empty crates 65 on board. The harvesting-cart 60 (re)starts harvesting a crop row by way of the crop-picking tool 63, which fills a crate 65 positioned in the collection zone 64.

Once the crate 65 in the collection zone 64 has been adequately filled, the filled crate 65 is transported and stacked toward the rear of the harvesting-cart 60 in the temporary storage area 66. Filled crates 65 already present in the temporary storage area 66 are raised by a lifting mechanism and the filled crate 65 is placed at the bottom of the stack.

Once the filled crate 65 is removed from the collection zone 64 an empty crate 65 is raised from an underlying supply of empty crates 65 and placed in the collection zone 64 for filling. It will be understood that the supply may be any of under, above, or alongside the collection zone 64 or variations between.

The supply of empty crates 65 is sourced from transport-cart 80 as follows. An empty crate 65 is removed from the bottom of the rear stack and placed upon a transport-belt to be transported to the harvesting-cart 60. In the illustrated embodiment, the transport belt underlies the empty crates 65 so that crates are transported under the overlying stacked crates 65. It will be understood that the transport-belt may be any of under, above, or alongside the collection zone 64 or variations between.

This action is repeated in coordination with the filling action of the harvesting-cart 60 to supply crates 65 as needed to the collection zone 64. Once the rear stack of empty crates 65 on the transport-cart 80 has been exhausted of supply, the further stacks on the transport-cart 80 are shifted rearwardly and an open volume is made available for receipt of a stack of filled crates 65, which is shifted from the temporary storage area 66 of the harvesting-cart 60 to the transport-cart 80.

This process is repeated until the transport-cart 80 is filled with full crates 65 or all available crop has been picked. If not all crop has been picked, the transport-cart 80 is transported back to the service-cart 100 and is exchanged for a transport-cart carrying empty crates 65, which couples to the picking-cart 60 and is subject to the filling process.

This process is continued until all available crop has been harvested.

It will be understood that the supply of the crates 65 may be operated in reverse of the above, in which empty crates 65 are provided to the collection zone 64 from a supply of empty crates 65 in the temporary storage area 66, whereafter a selected crate is filled and transported from the collection zone 64 to the rear of the transport-cart 80.

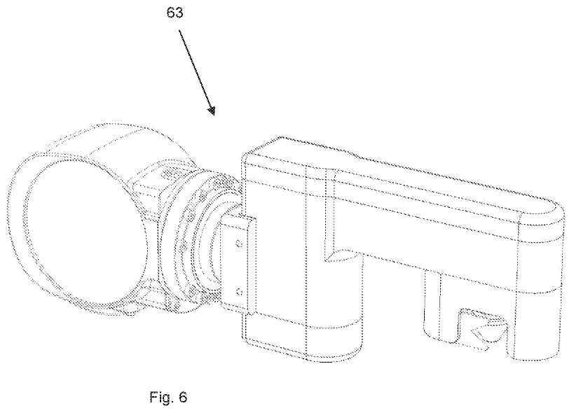

An example of a crop-picking tool is illustrated in FIG. 6. It will be appreciated that the crop-picking tool will be readily adapted to the size and characteristics of the crop that is to be harvested. In the illustrated, preferred embodiment, the crop-picking tool is comprised in a robot arm. The robot arm is preferably provided with a number of degrees of freedom to position and orient the pick-and-place head for pick up, transport, and placement of picked-up bulbs.

In some applications a robot arm having 4 degrees of freedom is provided, i.e. 3 rotation axes, where one axis is arranged to allow transfer along the axis (preferably in a direction substantially perpendicular to the bottom surface of the bulbs supply system) is sufficient. In alternative applications a more sophisticated robot arm is provided, for example a robot arm capable of picking crops in a variety of three-dimensional (3D) orientations. These more sophisticated robot arms may be arranged to operate with 6 degrees of freedom.

The robot arm is programmed to move the picking tool to a selected crop on the plant, and to position the picking tool in a suitable orientation to grasp and pluck a crop product. For this purpose, the crop position (for example using Cartesian-coordinates, as will be understood by a person skilled in the art) and the orientation of the crop are obtained using images from the camera system in combination with pattern recognition.

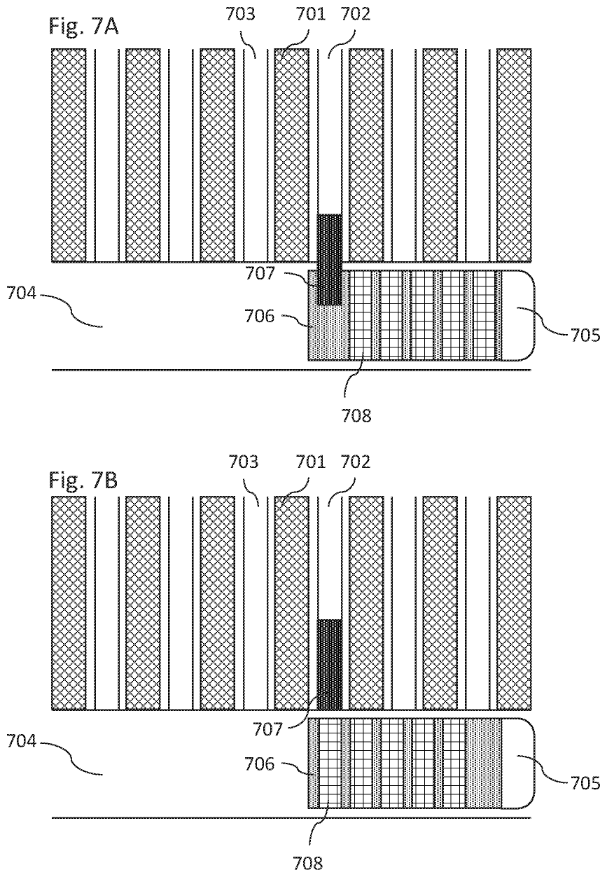

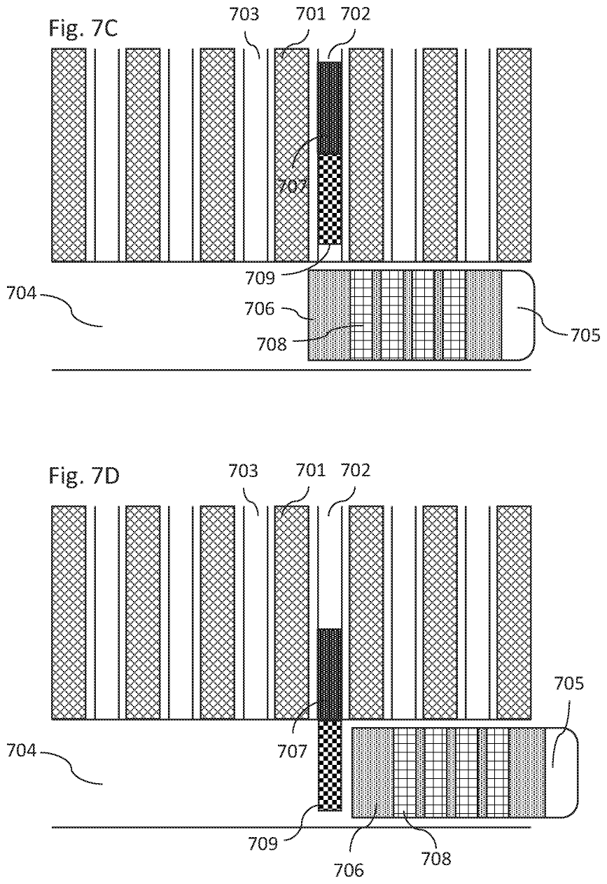

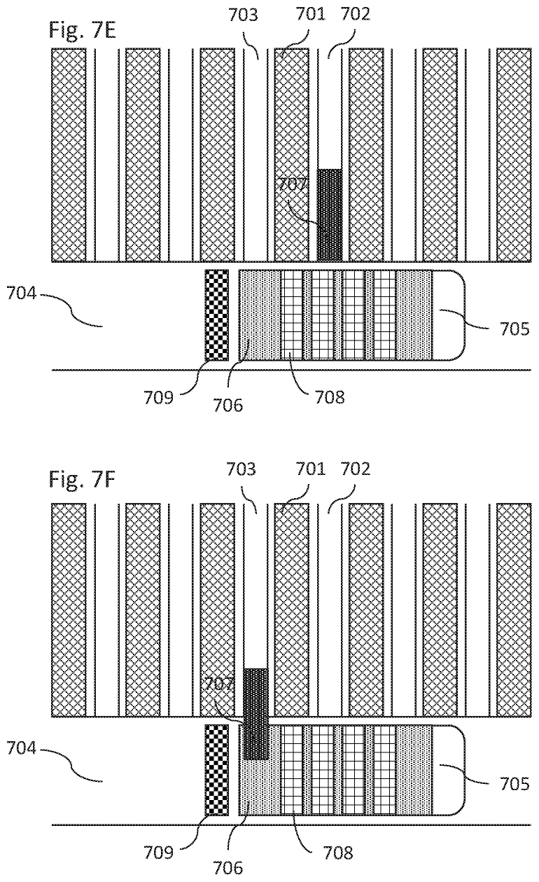

FIG. 7 A-F show an example implementation of the harvesting system for harvesting crop items from plants grown in rows performing the method for harvesting crops grown in rows. The environment in which the harvesting system operates may be a greenhouse or other environment, outside or inside, where crops grow in rows 701. Between each of the plurality of rows 701, there exists an inter-crop lane, which is a space between the rows of plants through which harvesting-cart 707 and transport-cart 708 can traverse. For illustrative purposes, in FIG. 7 A-F, there is provided a first inter-crop lane 702 and a second inter-crop lane 703. The ground within substantially parallel first and second inter-crop lanes 702 and 703, as well as any other inter-crop lanes described herein, may comprise regular ground, flooring, rails, heat exchanger tubes, or any other ground types upon which harvesting-cart 707 and transport-cart 708 can traverse using wheels and/or tracks.

Substantially perpendicular to the inter-crop lanes, there is provided connecting main lane 704. Alternatively, connecting main lane 704 may also be angled between 45° to 90° with respect to the inter-crop lanes. The ground of connecting main lane 704 may comprise regular ground, flooring, rails, heat exchanger tubes, or any other ground types upon which service-cart 705 can traverse using wheels and/or tracks.

Connecting main lane 704 may be positioned lower, higher, or be positioned at the same height as the (plurality of) inter-crop lane(s). Additionally connecting main lane 704 and the (plurality of) inter-crop lane(s) may be connected by rails. The intersection between connecting main lane 704 and the (plurality of) inter-crop lane(s) may also comprise ramps and/or other constructions provided for the transfer of harvesting-cart 707 and transport-cart 708 at the end of inter-crop lanes where the connecting main lane 704 begins.

FIG. 7 A-F further depict service-cart 705, which comprises loading platform 706 used for loading harvesting-cart 707 and (a plurality of) transport-cart(s) 708. Once loaded, service-cart 705 can safely traverse along connecting main lane 704 to transport harvesting-cart 707 and (a plurality of) transport-cart(s) 708 and unload them at any desired location, preferably near an end of an inter-crop lane. Additionally, service-cart 705 is capable re-positioning harvesting-cart 707 and (a plurality of) transport-cart(s) 708 while being loaded on the loading platform 706. Re-positioning of harvesting-cart 707 and (a plurality of) transport-cart(s) 708 may comprise moving one or more carts in the direction of the main connecting lane 704. The front of the service-cart 705 is identified as the right side of service-cart 705 and the end of service-cart 705 is identified as the left side of service-cart 705 as depicted in FIG. 7 A-F, respectively.

In addition, service-cart 705 is capable of loading and unloading harvesting-cart 707 and (a plurality of) transport-cart(s) 708 from the start (front) and end (back) of loading platform. Loading and unloading harvesting-cart 707 and (a plurality of) transport-cart(s) 708 can also be done on and from the longitudinal sides of loading platform 706, which are identified as the sides of service cart 705 that face and face away the inter-crop lanes in FIG. 7 A-F.

For the loading and unloading of harvesting-cart 707 and (a plurality of) transport-cart(s) 708 to and from loading platform 706, loading platform 706 may comprise ramps and/or other constructions provided for the transfer of harvesting-cart 707 and transport-cart 708 between loading platform 706 and an inter-crop lane and/or connecting main lane 704.

For the purpose of transferring harvesting-cart 707 and transport-cart 708 between inter-crop lanes, connecting main lane 704, and loading platform 706, loading platform 706, harvesting-cart 707 and/or transport-cart 708 may comprise wheels, linear actuators, suspension systems, swivel wheels, equipment for gaining or decreasing height, changing rail gauge, and/or equipment for transferring from one set of wheels or driving mechanism to another.

FIG. 7A depicts an example implementation of the harvesting system for harvesting crop items from plants grown in rows performing the method for harvesting crops grown in rows. Harvesting-cart 707 is unloaded from loading platform 706 of service-cart 705 and entering first inter-crop lane 702 located between crop rows 701. Unloading of harvesting-cart 707 can be achieved by harvesting-cart 707 driving off loading platform 706 by itself, but may also be achieved by service-cart 705 and or an apparatus located on loading platform 706 pushing, driving, and/or releasing harvesting-cart 707 off of loading platform 706. Unloading of harvesting-cart 707 may also comprise a hybrid form, in which service-cart 705 and harvesting 707 collaborate in the unloading process. For example, service-cart 705 may lower and/or slant loading platform 706 while harvesting-cart 707 drives off.

For harvesting cart 707 to start harvesting, it may be desirable to couple to transport-cart 708 to store picked crops. Given that transport-cart 708 is not aligned with first inter-crop lane 702, service-cart may either drive backward to align transport-cart 708 with first inter-crop lane 702 or re-position the plurality of transport-carts 708 on loading platform 706 itself, the result of which is shown in FIG. 7B. Re-positioning of harvesting-cart 707 and/or (a plurality of) transport-cart(s) on loading platform 706 may be performed by actuating a conveyor belt or actuating a pushing- or pulling-apparatus, for example by using linear actuators.

Once transport-cart 708 is aligned with first inter-crop lane 702, transport-cart 708 may proceed to be unloaded from loading platform 706 and be coupled to harvesting-cart 707. Coupling between harvesting-cart 707 and transport-cart 708 may be achieved by hooks, magnets, and/or other methods of detachably coupling two carts. Coupling may be performed once transport-cart 707 enters first inter-crop lane 702, but may also be done while transport-cart 708 is still (partially) loaded onto loading platform 706.

Unloading of transport-cart 708 may be active, passive, or hybrid, similarly to what was previously described for harvesting cart 707. In addition, transport-cart 708 may also be pulled off of loading platform 706 by harvesting-cart 707, since transport-cart 708 and harvesting-cart 707 may be coupled.

Once harvesting-cart 707 is (at least partly) positioned in first inter-crop lane 702, and transport-cart 708 is preferably coupled to harvesting-cart 707, harvesting-cart 707 can start picking crops using a picking tool. Alternatively, another transport-cart 708 may be coupled to already-coupled transport-cart 708. Once filled, like shown in FIG. 7C, it may be desirable for filled transport-cart 709 to be stored somewhere so that harvesting-cart 707 may be coupled to a new (empty) transport-cart 708 or move to a new inter-crop lane, such as second inter-crop lane 703. Nonetheless, especially given that harvesting-cart 707 is not coupled to any empty transport-carts 708, it is likely desirable that filled transport-cart 709 is stored.

It may be desirable to store filled transport-cart 709 on connecting main lane 704 at a position where it does not interfere with further harvesting operations. Suppose that second inter-crop lane 703 is to be harvested next, it may be desirable to store filled transport-cart 709 at a location left of inter-crop lane 703.

The first option for storing filled transport-cart 709 left of second inter-crop lane 703 comprises harvesting-cart 707 and filled transport-cart 709 exit first inter-crop lane 702, directly loading filled transport-cart 709 onto loading platform 706 of service-cart 705. Service-cart 705 may then proceed to drive towards the desired unloading-point and unload filled transport-cart 709 from the end of service-cart 705.

The second option for storing filled transport-cart 709 left of second inter-crop lane 703 is shown in FIG. 7 D-F. First, harvesting-cart 707 and filled transport-cart 709 exit first inter-crop lane 702, transferring filled transport-cart 709 to connecting main lane 704, as shown in FIG. 7D. Next, filled transport-cart 709 may be decoupled from harvesting-cart 707, leaving harvesting-cart 707 in first inter-crop lane 702 and filled transport-cart 709 on connecting main lane 704. Next, service-cart 705 may push filled transport-cart 709 left of second inter-crop lane 703, as shown in FIG. 7E, without loading filled transport-cart 709 onto loading platform 706 of service-cart 705.

To push harvesting-carts and/or transport-carts, service-cart 705 (or any other service-carts described herein), may comprise pushing elements, for example a bumper, protrusion and/or a pad attached to the front and/or backside of service-cart 705. Said pushing elements may additionally comprise springs for absorbing shocks that may occur when harvesting-carts and/or transport carts collide with the service-cart upon first contact. During pushing, service-cart 705 may also partly lift harvesting-carts and/or transport-carts.

After pushing filled service-cart 709 left of second inter-crop lane 703, harvesting-cart 707 may then be transported from first inter-crop lane 702 to second inter-crop lane 703 by loading and unloading harvesting-cart 707 onto and from service-cart 705. First, service-cart 705 drives forward to align an empty spot on loading platform 706 with first inter-crop lane 702. Harvesting-cart 707 may then proceed to be loaded onto loading platform 706 of service-cart 705, after which service-cart 705 drives backward and aligns loaded harvesting-cart 707 with second inter-crop lane 703. The method for harvesting crops grown in rows may then repeat, this time starting from second inter-crop lane 703.

Looking at FIG. 7E, in which service-cart 705 pushes filled transport-cart 709 left of second inter-crop lane 703, service-cart could have also first pushed filled transport-cart 709 left of first inter-crop lane 702 and loaded harvesting-cart 707 onto loading platform 706. In doing so, service-cart 705 may combine the steps of pushing filled service-cart 709 left of second inter-crop 703 and aligning harvesting-cart 707 with second inter-crop lane 703.

It should be appreciated that the presented harvesting system is highly-flexible and modular in the sense that endless configurations and planning methods for organizing empty- and filled transport-carts, as well as where to deploy harvesting-carts. Further, the harvesting system and method described herein may also be deployed in environments where the connecting main lane is surrounded by inter-crop lanes on both the upper- as well as the lower-side.

Further modifications in addition to those described above may be made to the structures and techniques described herein without departing from the spirit and scope of the invention. Accordingly, although specific embodiments have been described, these are examples only and are not limiting upon the scope of the invention.

In the following paragraphs, clauses are disclosed. Any of the clauses can be combined with any of the respective claims.
1. A harvesting system for harvesting crop items from plants grown in rows, comprising:
at least one harvesting-cart for harvesting said crops, the harvesting-cart comprising:
a detection unit arranged to identify crop items for harvesting;
a crop picking tool arranged to pick crop items identified by the detection unit; wherein
the harvesting-cart is arranged to be movable along inter-crop lanes defined between said rows of plants;
a plurality of transport-carts, each transport-cart arranged to be detachably coupled to the at least one harvesting-cart, each transport-cart comprising a holding region for storing a plurality of crop-containers; and
a service-cart for transferring said transport-carts, and preferably said harvesting-cart, to and from said inter-crop lanes.
2. A method for harvesting crops grown in rows, comprising the steps of:
delivering a harvesting-cart and a transport-cart to a designated lane between crop rows;
identifying crops for picking by way of a detection unit, preferably on said harvesting-cart,
picking said identified crops using a picking tool on said harvesting-cart,
passing picked crops to one or more containers;
passing said one or more containers to a storage position on said transport-cart, wherein the transport-cart is arranged to be detachably connected to the harvesting-cart, and further comprises a buffer region for receiving a plurality of containers;
coupling the one or more of the harvesting-cart and/or the transport-cart to a service-cart, wherein the service-cart is arranged to move said transport-cart between designated lanes and a storage location along a direction substantially orthogonal to the lanes between the crops.
3. A harvesting-cart for picking crops, arranged to be movable along the lanes defined between the rows of crops, comprising:
a detection unit for identification of harvestable crops;
a picking tool for harvesting identified crops; and
preferably a collecting region arranged to hold a container for receiving picked crops.
4. The harvesting-cart of clause 3, wherein the detection unit is arranged to detect and select the crops, preferably wherein the detection unit defines pre-determined selection criteria for selecting the crops, more preferably wherein the pre-determined selection criteria comprise one or more of the state of ripeness, the state of degradation, and optical characteristics associated with disease infection.
5. The harvesting-cart of any of clauses 3-4, wherein the detection unit comprises a plurality of detectors arranged in different vertical locations for detecting crops at different heights.
6. The harvesting-cart of any of clauses 3-5, wherein the harvesting-cart further comprises a temporary storage area for storing one or more of the containers.
7. The harvesting-cart of any of clauses 3-6, wherein the harvesting-cart further comprises a plurality of wheels for moving on any or all of the ground, on tubes, or on rails.
8. A transport-cart for transporting harvested crops comprising:
a buffer region for receiving one or more containers;
a container control unit for controlling the relative positions of the one or more containers based on the number of harvested crops and/or amount of harvested crop, for example, weight or volume.
5. A service-cart for transporting harvesting-carts, and transport-carts to a designated lane between rows of crops comprising:
an electric power cable arranged to supply electric power to a harvesting-cart;
a buffer region for storing one or more carts including the harvesting-cart;
a connection control system arranged to control the physical connection status with the one or more carts.

1. A harvesting system for harvesting crop items from plants grown in rows, comprising:
at least one harvesting-cart for harvesting said crops, the harvesting-cart comprising:
a detection unit arranged to identify crop items for harvesting;
a crop picking tool arranged to pick crop items identified by the detection unit;
wherein the harvesting-cart is arranged to be movable along inter-crop lanes defined between said rows of plants;
a plurality of transport-carts, each transport-cart comprising a holding region for storing a plurality of crop-containers; and
a service-cart for transferring said transport-carts and/or said harvesting-cart, to and from said inter-crop lanes,
wherein the service-cart is configured to load the at least one harvesting-cart and/or the plurality of transport carts onto the service-cart.

2. The harvesting system of claim 1, wherein the service-cart is configured to lift the at least one harvesting-cart and the plurality of the transport-carts to and from said inter-crop lanes, wherein preferably the service-cart is arranged to load/lift the at least one harvesting-cart and/or the transport carts such that the at least one harvesting-cart and the transport-carts are not in contact with the ground on which the service-cart transports.

3. The harvesting system of any preceding claim, wherein the service-cart has a loading platform for supporting at least one harvesting-cart and at least one transport-cart, wherein preferably the loading platform has multiple adjacent loading spots for carts, and wherein more preferably the service-cart has a drive-unit for moving one or more transport-carts from loading spot to a different loading spot on the loading platform.

4. The harvesting system of any preceding claim, wherein the detection unit is arranged to identify and select ripe crops, preferably wherein the detection unit defines pre-determined selection criteria for selecting the crops, more preferably wherein the pre-determined selection criteria comprise one or more of the level of ripeness, the level of degradation, and optical characteristics associated with disease infection; preferably the selection criteria include one or more of: color, size, aspect ratio and shape.

5. The harvesting system of any preceding claim, wherein the detection unit comprises a plurality of detectors arranged at different vertical locations for detection of crops at different heights in a row.

6. The harvesting system of any preceding claim, wherein the harvesting-cart further comprises one or more of; a temporary storage area for storing one or more of the containers, and/or a collection zone arranged to accept a crop-container, said crop-container arranged to receive picked crop items, wherein the collection zone is comprised in one or both of said harvesting-cart or said transport-cart.

7. The harvesting system of any preceding claim, wherein the harvesting system further comprises a movement mechanism for the movement of the at least one harvesting-cart, the least one transport-cart, and the service-cart, the movement mechanism comprises a plurality of wheels for moving on the ground, on tubes, or on rails installed on the ground.

8. The harvesting system of any preceding claim, wherein the harvesting-cart is electrically powered, preferably by an electrical feed cable running from the service-cart to the harvesting-cart, or by rechargeable battery.

9. The harvesting system of any preceding claim, wherein the harvesting system further comprises a movement control system for controlling the movement of the harvesting-cart, the plurality of transport-carts, and the service-cart.

10. The harvesting system of any preceding claim, wherein each transport-cart is arranged to be detachably coupled to the at least one harvesting-cart, and wherein preferably the harvesting system further comprises a connection control system arranged to control physical coupling between the harvesting-cart, the transport-carts, and the service-cart.

11. The harvesting system of any preceding claim, wherein the crop-container is a box or a crate, wherein preferably the transport-cart further comprises a container control unit for controlling the relative positions of containers in the number of containers based on the quantity of harvested crop.

12. The harvesting system of any preceding claim, wherein the service-cart is electrically connected to a power source, external to the service-cart, by a cable, wherein the service-cart further comprises a reel for housing the cable.

13. The harvesting system of claim 12, wherein the plurality of transport-carts and/or the at least one harvesting cart are electrically connected, via the service-cart, to a power source, external to the plurality of transport-carts and/or the at least one harvesting cart, by a cable, wherein preferably the plurality of transport-carts and/or the at least one harvesting cart further comprises at least one reel for housing the cable.

14. The harvesting system of any preceding claim, wherein loading and/or lifting of the at least one harvesting-cart and the plurality of transport carts further comprises a docking system for providing power to the at least one harvesting-cart and/or the plurality of transport carts, wherein preferably the plurality of transport-carts and/or the at least one harvesting cart comprise at least one battery.

15. The harvesting system of any preceding claim, wherein the plurality of transport-carts and/or the at least one harvesting cart each further comprise at least two swivel wheels.

16. A method for harvesting crops grown in rows, comprising the steps of:
providing a harvesting-cart and a transport-cart to a first inter-crop lane, located between two rows of crops and providing a service-cart near an end of the first inter-crop lane;
picking crops using a picking tool on said harvesting-cart;
loading the harvesting-cart and/or the transport-cart onto the service-cart; and
moving the loaded service-cart to an end of a second inter-crop lane, located between two other rows of crops to deliver the harvesting-cart and the transport-cart to the second inter-crop lane,
wherein the first and second inter-crop lanes are positioned substantially parallel to each other.

17. The method of claim 16, wherein transferring the transport-cart or harvesting-cart from one to another inter-crop lane comprises carrying the transport-cart or harvesting-cart by the service cart.

18. The method of claim 16 or 17, wherein loading or unloading the transport-cart or harvesting-cart onto or from the service-cart comprises lifting the transport-cart or harvesting-cart,
wherein preferably the one or more transport-carts and/or the harvesting-cart are loaded onto a loading platform on the service-cart.

19. The method of claim 16, 17 or 18, wherein loading or unloading the transport-cart or harvesting-cart onto or from the service-cart comprises moving the transport-cart in a direction along the length of the inter-crop lane, which preferably extends generally perpendicular to the transfer direction,
wherein preferably the orientation of the transport-cart and/or harvesting cart is maintained during loading, transferring and/or unloading the service cart.

20. The method of any of the claims 16-19, wherein the method further comprises passing picked crops to one or more containers and passing said one or more containers to a storage position on said transport-cart, wherein the transport-cart is detachably connected to the harvesting-cart,
wherein the method further preferably comprises buffering a plurality of containers on the harvesting-cart.

21. The method of any of claims 16-20, wherein the method comprises identifying crops for picking by way of a detection unit, preferably located on said harvesting-cart, wherein picking crops comprises picking identified crops, wherein preferably the pre-determined selection criteria are used for selecting the crops, more preferably wherein the pre-determined selection criteria comprise one or more of the state of ripeness, the state of degradation, and optical characteristics associated with disease and/or infection.

22. The method of any of claims 16-21, wherein the harvesting-cart is electrically powered by via the service-cart.
